(19) United States
(12) Patent Application Publication
(10) Pub. No.: US 2016/0037129 A1
(43) Pub. Date: Feb. 4, 2016

(54) Method and Apparatus for Enhanced Caller ID

(71) Applicant: Cisco Technology, Inc., San Jose, CA (US)

(72) Inventors: Kristian Tangeland, Oslo (NO); Vigleik Norheim, Oslo (NO); Vegard Hammer, Oslo (NO)

(21) Appl. No.: 14/449,589

(22) Filed: Aug. 1, 2014

(51) Int. Cl. H04N 7/15; G06K 9/00; H04N 5/225

(52) U.S. Cl. CPC H04N 7/152; H04N 5/225; G06K 9/00221; G06K 2209/27

(57) ABSTRACT

In one embodiment, a method is provided for handling a call from a conferencing endpoint configured to handle a conference between multiple participants. A request to call a participant is received from the conferencing endpoint. Information is inferred about a presence of one or more participants in the call, based on a detection of the one or more participants by presence detection equipment associated with the conferencing endpoint;. Additional call context information is determined based on the inferred information. The additional call context information is provided to the participant in addition to the call, wherein the additional call context information is accessible to the participant.

### TECHNICAL FIELD

The present disclosure relates generally to telecommunications and, more specifically but not exclusively, to conferences.

### BACKGROUND OF THE INVENTION

In the field of communications, the role of conferencing has increased, and more and more companies of various sizes and types use conferencing tools, such as audio and/or video conferencing tools.

There are two main types of conferences, i.e. pre-planned (or pre-scheduled) conferences and ad-hoc conferences. There is a fundamental difference between a pre-planned conference and an ad-hoc conference.

In a pre-planned conference, an inviting participant sends an invitation e.g. via email to one or more invited participants, ahead of the considered starting time of the conference. The invitation usually comprises information such as a title and/or an agenda and/or an expected duration, and the invited participants can usually also see the other invited participants in receipt of the invitation. During the ahead-of-time scheduling of the conference, each of the invited participants may consider if they are interested in participating in the conference, based e.g. on the title and/or the agenda and/or the other invited participants. In other words, the decision to accept the invitation is usually a fully informed decision in the case of a pre-planned conference. Each of the interested invited participants investigates their calendar for checking their availability for the considered starting time and the duration of the conference. The interested invited participants who are available may then accept the invitation, which triggers a pre-registration to a conference managing system and a reservation of endpoints associated with the invited participants in a capability and booking database, for scheduling conferences from the starting time and for the duration of the conference. At the starting time of the pre-planned conference, the conference managing system may call the reserved endpoints and the conference commences.

On the contrary, in an ad-hoc conference, a participant who is not expecting a call is called to participate in a conference. For example a conference, such as a conference call or a video conference, may be attended by a number of participants, and during the conference, the need to conference in another participant may arise. In this case, one of the participants may decide to call the invited participant. For example, the inviting participant may place the conference on hold and out-dial the invited participant's number. In an ad-hoc conference, the inviting participant may directly interact with the ad-hoc invited participant, i.e. without interaction with a capability and booking database, or may use a conference managing system. If the ID of the caller endpoint is not pre-registered with the endpoint of the invited participant, an uninformative message such as “incoming call” or “anonymous” is usually displayed to the invited participant. Even if the caller endpoint is pre-registered with the endpoint of the invited participant, only the ID of the inviting participant or the ID of the endpoint associated with the inviting participant is displayed in a caller ID associated with the call, which may simply be a generic conference room, a Session Initiation Protocol (SIP) Uniform Resource Identifier (URI) or an Internet Protocol (IP) address.

### BRIEF DESCRIPTION OF THE FIGURES

FIG. 1 depicts a system for handling a call according to an example embodiment of the present disclosure;

FIG. 2 depicts an embodiment of a call manager according to example embodiments of the present disclosure;

FIG. 3 depicts an example interface rendering the call context information according to an example embodiment of the present disclosure;

FIG. 4 depicts a simplified flow chart of a method for handling a call according to one embodiment of the present disclosure;

FIG. 5 depicts a simplified flow chart of a method for handling a SIP session according to one embodiment of the present disclosure; and

FIG. 6 depicts a simplified flow chart of a method for handling a call to a mobile phone according to one embodiment of the present disclosure.

### DESCRIPTION OF EXAMPLE EMBODIMENTS

Overview

An example method is provided and includes receiving a request to call a participant from a conferencing endpoint configured to handle a conference between multiple participants; inferring information about a presence of one or more participants in the call, based on a detection of the one or more participants by presence detection equipment associated with the conferencing endpoint; and determining additional call context information based on the inferred information. The method also includes providing the additional call context information to the participant in addition to the call. In some examples, the additional call context information may be accessible to the participant.

### DETAILED DESCRIPTION OF EXAMPLE EMBODIMENTS

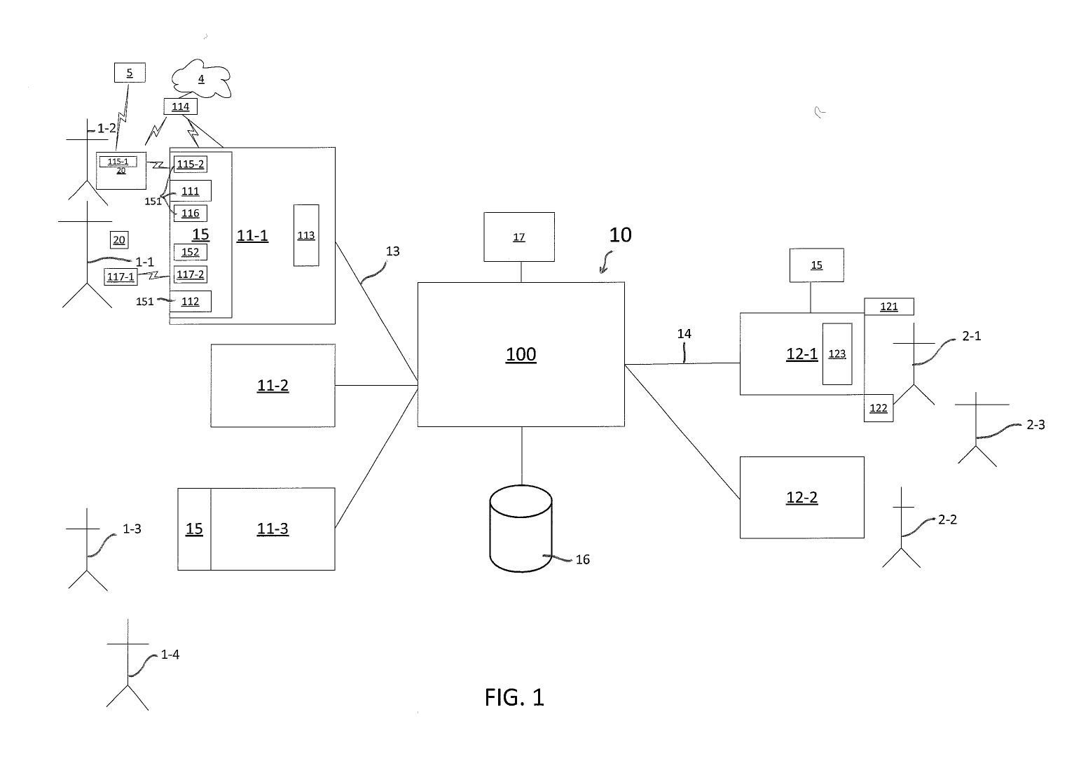

FIG. 1 schematically illustrates an apparatus 10 configured to handle a call from one or more conferencing endpoints 11, such as endpoints 11-1, 11-2 and 11-3 of FIG. 1. In some examples, the call may be directed to one or more conferencing endpoints 12, such as endpoints 12-1 and 12-2 of FIG. 1.

In some embodiments, the apparatus 10 may be configured to generate a call request from the endpoint 11-1 to the endpoint 12-1 to initiate a call. As explained in further detail below, in some examples the apparatus 10 may further be configured to generate a set of call notification parameters (CNP) when the call request is generated and the call is initiated. For example the CNP may allow the endpoint 12-1 to render a rich call notification, for example comprising the additional call context information, when the call (i.e. the call request) is provided to the endpoint 12-1. In some examples, the CNP may be part of the call request. Alternatively or additionally, the CNP may be sent in parallel of the call request using a similar control protocol. Alternatively or additionally, the CNP may be sent as side information using a separate and different control protocol compared to the call request. As will be apparent in the present description, other ways to transmit the CNP to the endpoint 12-1 may be envisaged.

As already mentioned, in some embodiments, the endpoint 12-1 may be configured to render the rich call notification, for example comprising the additional call context information, based on the CNP received by the endpoint 12-1. In some embodiments, the additional call context information may be comprised in the CNP. Alternatively or additionally, the endpoint 12-1 may further be configured to retrieve the additional call context information based on the CNP, e.g. from storage. In some examples the storage may comprise a memory and/or a server and/or a database and/or a directory. In some examples the server may be local to the endpoint 12-1 or may be remote from the endpoint 12-1, and may be located in a “cloud” 30 server.

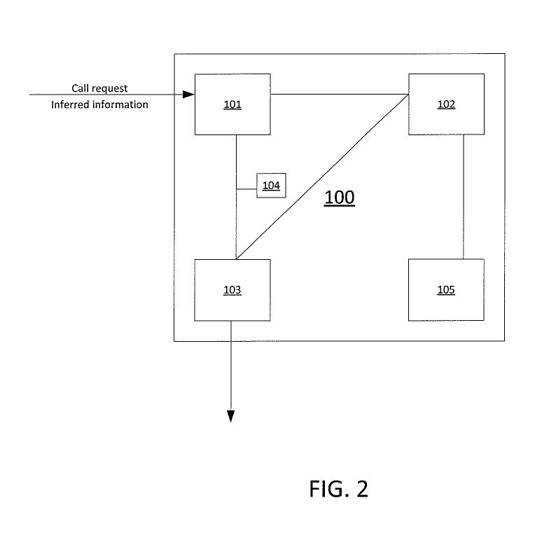

As schematically illustrated in FIGS. 1 and 2, in embodiments, the apparatus 10 may comprise a call manager 100 and the one or more conferencing endpoints 11 and/or 12. In some examples the CNP may be generated by the endpoints 11 and/or the call manager 100.

In some examples the additional call context information may be determined by the endpoints and/or the call manager 100.

In some embodiments, the apparatus 10 may further comprise presence detection equipment (or presence detector) 15.

In embodiments, the apparatus 10 may further comprise at least one portable personal device 20.

In some examples, the additional call context information may be determined based on information inferred from the presence detection equipment 15. In some examples the additional call context information may comprise information derived from storage and/or from the portable personal devices 20.

For example the endpoints 11 may be configured to handle a conference between multiple participants 1 and 2. In the example of FIG. 1, the participants 1 may comprise first (for example calling) participants 1-1, 1-2 and/or 1-3, 1-4. In the example of FIG. 1, the participants 2 may comprise second (for example invited or called) participants 2-1, 2-3 and/or 2-2. For example the call may occur between only two participants, e.g., a first participant 1-1 and a second participant 2-1.

In some examples, all the participants 1 (for example comprising the first participants 1-1, 1-2 and/or 1-3, 1-4) associated with the endpoints 11 (such as endpoints 11-1, 11-2 and/or 11-3) and all the participants 2 (for example comprising the second participants 2-1, 2-3 and/or 2-2) associated with the endpoints 12 (such as endpoints 12-1 and/or 12-2) may be called by the apparatus 10. In some examples, the call manager 100 may perform all the calls out to the endpoints 11 and 12, for examples for scheduled conferences, such that all the participants 1 and 2 are invited into a conference.

In some examples, all the participants 1 (for example comprising the first participants 1-1, 1-2 and/or 1-3, 1-4) associated with the endpoints 11 (such as endpoints 11-1, 11-2 and/or 11-3) and all the participants 2 (for example comprising the second participants 2-1, 2-3 and/or 2-2) associated with the endpoints 12 (such as endpoints 12-1 and/or 12-2) may call the apparatus 10. In some examples, all the endpoints 11 and 12 may call into a central server, such as the call manager 100, as a non-limiting example.

The call between the endpoints 11 and the endpoints 12 may be an audio call and/or a video call, using communication networks 13 and 14.

The endpoints 11 or 12 may include any devices used by a participant 1 or 2 to participate in the call. For example, the endpoints 11 or 12 may include any communications device, such as a cellular phone, Plain Old Telephone Service (POTS) telephone, a voice client on a computer such as e.g. a voice-enabled Instant-Imaging (IM) client, an Internet-enabled Voice over Internet Protocol (IP) (VoIP) device, a soft phone, a video conferencing end device, an instant messaging client, etc.

In some examples the endpoints 11 may be configured to generate the call request to initiate a call.

As already mentioned, in some examples the endpoints 11 may be configured to generate the set of CNP when the call request is generated and the call is initiated.

In some examples, the endpoints 12 may be configured to generate a call notification based on the CNP when the call request and the CNP are received by the endpoints 12. In some examples, the additional call context information may be accessible to the called participants 2-1 and 2-3 in the call notification. In some examples, the endpoint 12-1 may create and display the call notification comprising the additional call context information.

In some examples, the called participant 2-1 may use settings, e.g. saved locally on the endpoint 12-1, for setting a set of options for the rendering (e.g., layout and/or amount of information) of the call notification.

In the example of FIG. 1, the endpoints 11 or 12 are video conference endpoints, which can assist in receiving and communicating video and audio data. It is however appreciated that such endpoints 11 or 12 could be of a different type, as already mentioned. For example an endpoint 11 or 12 may further comprise a keyboard or other terminal equipment such as a remote controller and/or a touch pad and/or a mouse.

In the example illustrated in FIG. 1, the endpoint 11-1 comprises at least one camera 111, at least one microphone 112 and at least one screen 113, and the endpoint 12-1 comprises at 25 least one camera 121, at least one microphone 122 and at least one screen 123.

Each screen 113 or 123 can display images to be seen by the participants e.g., participants 1-1, 1-2, 2-1, and 2-3.

As explained in further detail below, in some examples the video conference technology of the apparatus 10 can simulate an in-person lifelike meeting experience for its participant(s) 1-1 to 1-4, or 2-1 to 2-3.

In some examples, the endpoints 11 and 12 may be respectively associated with the participants 1 or 2 in the call. For example, each endpoint 11 or 12 may be associated with at least one participant. In the example of FIG. 1:
the endpoint 11-1 is associated with the first participants 1-1,
the endpoint 11-3 is associated with the first participants 1-3,
the endpoint 12-1 is associated with the second participants 2-1, and
the endpoint 12-2 is associated with the second participant 2-2.

In general, the endpoints 11 and 12 may be geographically separated. Each endpoint 11 or 12 may be located, for example, in a meeting room or on a desk of the participant(s) 1-1 to 1-4, or 2-1 to 2-3. It is however appreciated that such endpoints 11 or 12 could be provided in any other suitable location, as FIG. 1 only offers one of a multitude of possible implementations according to the disclosure discussed herein.

In some embodiments, the endpoints 11 and 12 may further be associated with the presence detection equipment 15. Alternatively or additionally, the endpoints may be configured to comprise at least some of the functionalities or elements of the presence detection equipment 15.

In embodiments, the call manager 100 may be configured to handle the call from, e.g., the conferencing endpoint 11-1 configured to handle a call and/or a conference between the participants 1-1 and 1-2 and the participants 2-1 and/or 2-3 and/or 2-2. In the example illustrated in the FIGS. 1 and 2, the call manager 100 may be configured to receive the request to call the called participant, e.g., participant 2-1, from the conferencing endpoint 11-1. As already mentioned, in the example illustrated in the FIGS. 1 and 2, the call manager 100 may be configured to further receive CNP generated by the endpoint 11-1 for the endpoint 12-1.

Alternatively or additionally, the call manager 100 may be configured to generate the call request and/or the CNP for the endpoint 12-1.

In the example illustrated in the FIGS. 1 and 2, the call manager 100 may be configured to infer information about a presence of one or more participants 1-1 and 1-2 in the call, based on a detection of the one or more participants 1-1 and 1-2 by the presence detection equipment 15 associated with the conferencing endpoint 11-1.

Alternatively or additionally, the endpoint 11-1 may be configured to infer information about a presence of one or more participants 1-1 and 1-2 in the call.

In some embodiments, the inferred presence information may be comprised in the CNP. Alternatively or additionally, the inferred presence information may be sent in parallel of the call request and/or the CNP using a similar control protocol. Alternatively or additionally, the inferred presence information may be sent as side information using a separate and different control protocol compared to the call request and/or the CNP.

In the example illustrated in the FIGS. 1 and 2, the call manager 100 may be configured to determine the additional call context information based on the inferred information. In embodiments, the call manager 100 may be configured to provide the additional call context information to the one or more called participants, e.g. the participants 2-1 and 2-3 via the endpoint 12-1, in addition to the call (i.e. the call request). In some examples, the call manager 100 may be configured to determine the additional call context information based on the received inferred information. In some embodiments, the additional call context information may be comprised in the inferred information. Alternatively or additionally, the call manager 100 may further be configured to retrieve the additional call context information based on the inferred information, e.g. from storage.

As already mentioned, alternatively or additionally, the endpoint 12-1 may be configured to determine the additional call context information based on the inferred information.

If the called participants 2-1 and 2-3 answer the call, the call manager 100 may conference the endpoint 12-1 into the call. Also, in some examples, the call manager 100 may transfer the call to a device which can conference the endpoint 12-1 into the call, such as a bridge.

FIG. 2 schematically illustrates a more detailed embodiment of the call manager 100 according to one embodiment of the present disclosure. As shown, the call manager 100 illustrated in FIG. 2 may include a call request receiver 101, a determiner 102, a communicator 103 and a message builder 104. In some examples, the call manager 100 may further comprise a memory 105. It will be understood that variations of the call manager 100 may be appreciated. As already mentioned, alternatively or additionally, at least some of the functionalities and/or elements of the call manager 100 may be included in the endpoint 11-1. In some examples, the call request receiver 101 may be configured to receive the request to call the called participant, e.g., the participant 2-1, from the conferencing endpoint 11-1.

As explained in further detail below, in some examples, the presence detection equipment 15 associated with the conferencing endpoint 11-1 may be configured to infer information about a presence of the one or more participants 1-1 and 1-2 in the call, and the call request receiver 101 may be further configured to receive the inferred information from the presence detection equipment 15.

In some examples, the determiner 102 may be configured to determine the additional call context information based on the inferred information.

In some examples, the communicator 103 may be configured to provide the additional call context information to the called participant 2-1 in addition to the call. In some examples, the additional call context information may be accessible to the called participants 2-1 and 2-3.

Embodiments of the present disclosure provide many advantages. For example, a called participant may be informed that the call is coming from an individual, on behalf of a call or conference comprising several participants. Additional call context information may be provided such that the called participant can make an informed decision as to whether to answer the call and/or to accept the invite to the conference, or not. Accordingly, the called participant can decide whether to answer the call using the additional call context information provided in the call or in an invite message. The called participant may know the number of participants and/or the ID of the participants who are participating in the call or the conference. Further details about the participants may be included in the additional call context information. Thus, an informed decision as to whether the call or the invite message should be answered can be made. In embodiments, the called participant may not be an existing participant in the conference but still can access the additional call context information.

In some examples, the additional call context information may be determined based on inferred presence information without the need for the participants to pre-register to the apparatus for a pre-planned conference or for a call. In some examples, the information may be inferred automatically. In some examples, the information may be inferred on request, e.g., from the calling participant.

In some examples, even if not all of the participants are recognized (for examples in cases where the faces of the detected participants are not recognized or are not in storage), the apparatus may be configured to provide valuable and useful additional call context information, by providing for example at least a head count of the not identified participants.

In some examples, when the conference is pre-registered, the apparatus may include further information about the pre-registered conference, for example the title of the conference and/or the invited participants and/or the accepted participants and/or other available information about the conference (for example available using software known as Exchange or other) in the additional call context information (for example as a topic of the conference and/or title of the call notification), thus providing valuable and useful additional call context information to the called participant.

In some examples, if a file, such as a using software known as Powerpoint or Word, is being presented when the call is initiated, the apparatus may include the name of the file in the additional call context information (for example as a topic of the conference and/or title of the call notification), thus providing valuable and useful additional call context information to the called participant.

In some examples, the endpoint 11-1 may send a call request to the call manager 100, and the call request receiver 101 may be configured to receive the call request from the endpoint 11-1. For example, the participant 1-1 may perform the call request by dialing (e.g., using a public switched telephone networks (PSTN) line) the number of the called participant 2-1.

It is appreciated that different types of networks 13 and 14 may be used for the call or the conference, such as a PSTN, as already mentioned, and/or an Integrated Services for Digital Network (ISDN) network, and/or an Internet Protocol (IP) network.

It is also appreciated that different protocols may be used for the call and/or the conference. In some examples, the H.320 standard (for examples for PSTN and/or ISDN lines), such as the H.323 standard, may be used. In some examples, the H.264 standard may be used (for example for IP lines). In some examples, the V.80 standard may be used (for example for POTS lines). In some examples, the call is a video conference call may be implemented in a Session Initiation Protocol (SIP) environment.

As explained in further detail below, in some examples, the endpoint 12-1 may comprise a mobile and/or cellular and/or satellite telephone, and the Global System for Mobile Communications (GSM), General Packet Radio Services (GPRS), Enhanced Data rates for GSM Evolution (EDGE), third generation Universal Mobile Telecommunications System (UMTS), and fourth generation Long Term Evolution (LTE), and/or Code Division Multiple Access (CDMA), CDMA200, WCDMA, and/or Time Division Multiple Access (TDMA) protocols may be used.

In some examples, the call request receiver 101 may be configured to further determine the called participant 2-1 indicated in the call request. For example the call request receiver 101 may determine which participant 2-1 to call from a memory 16, forming for example a 30 directory. In some examples, the memory 16 may be located in a server. In some examples, the server may be distributed in a “cloud” configuration.

In some examples, the presence detection equipment 15 may include any appropriate combination of hardware and/or software for providing any of the features discussed herein. In embodiments, the presence detection equipment 15 may receive and/or analyse signals (such as information and/or audio and/or video streams) from the apparatus 10, such as the call manager 100 and/or the endpoint 11-1. Additionally or alternatively, the presence detection equipment 15 may receive and/or analyse signals from a portable personal device 20 and/or an access point 114 of a communications network 4 and/or a location system 115 and/or an ultrasound transceiver 116 an identification system 117.

In some examples, the presence detection equipment 15 may use the result of the analysis as a basis for a detection of the one or more participants 1-1 and 1-2, and thus for an inferring of information about a presence of one or more participants 1-1 and 1-2 in the call.

As already mentioned, alternatively or additionally, the endpoint 11-1 may be configured to comprise at least some of the functionalities or elements of the presence detection equipment 15.

In some examples, the presence detection equipment 15 may comprise at least one arrangement comprising an element 151, comprising hardware and/or software and/or firmware, and logic 152.

In some examples, the element 151 of the arrangement may comprise a camera, such as for example the camera 111, and the logic 152 may comprise image analysis logic configured to infer the information using for example face detection, face recognition and/or head count. For example the camera 111 may be configured to, upon detecting motion, perform face detection and compare the detected faces with a database, such as a directory (for example a company directory and/or a facial database) to count and/or identify the participants. The participants 1-1 and 1-2 in a field of view (FOV) of the element 151 (usually blocked by walls of a room) are thus counted and/or identified, and the inferring may thus comprise detecting the presence of one or more participants in a room where the conferencing endpoint is located.

Additionally or alternatively, in some examples, the element 151 of the arrangement may comprise a microphone, such as for example the microphone 112, and the logic 152 may comprise audio analysis logic configured to infer the information using for example voice detection and/or voice recognition. The participants 1-1 and 1-2 in an audible range of the element 151 (usually blocked by walls of a room) are thus counted and/or identified, and the inferring may thus comprise detecting the presence of one or more participants in a room where the conferencing endpoint is located.

Additionally or alternatively, in some examples, the element 151 of the arrangement may comprise an ultrasound transceiver 116, and the logic 152 may comprise device detection logic configured to infer the information by detecting ultrasound emitted or received by personal portable devices 20 associated with the one or more participants 11-1 or 11-2. In some examples the apparatus may be configured to perform a mapping of personal portable device 20 located near the endpoint 11-1. As explained below, in some examples, the arrangement may be configured to detect the presence of a wireless personal portable device 20. In some examples, the endpoint 11-1 may be configured to use ultrasonic information pairing the endpoint 11-1 with a personal portable device 20. In some examples, the personal portable device 20 may exchange signals with the endpoint 11-1, e.g., Wi-Fi signals. In an example, the exchanged Wi-Fi signals may include signals for a synchronization of the internal clocks of the personal portable device 20 and of the transceiver 116. Further, the exchanged signals may include time information for ultrasound audio signals emitted by the transceiver 116 and received by the personal portable device 20 and/or emitted by the personal portable device 20 and received by the transceiver 116. The exchanged ultrasound audio signals may be used by the personal portable device 20 and/or by the logic 152 to calculate the time of flight (TOF) of the ultrasound audio signal and/or identify the device 20. In some examples, the TOF may be used to determine actual distance of the personal portable device 20 to the transceiver 116. In some examples, if the logic 152 determines that the personal portable device 20 is located at an actual distance below a predetermined threshold, presence information may be inferred about the presence of the corresponding personal portable device 20, and thus information about the presence of the corresponding participant may be inferred. For example, the participant may be counted and/or identified, for example based on a count and/or ID of the corresponding personal portable device 20. The Wi-Fi signals and/or the ultrasounds may have a short range and may be blocked by walls of a room where the conferencing endpoint is located, and the personal portable devices 20 detected may correspond to participants in the room where the conferencing endpoint is located. Additionally or alternatively, the threshold may correspond to a size of a room where the conferencing endpoint is located.

Additionally or alternatively, in some examples, the element 151 of the arrangement may comprise an access point 114 of a communications network 4, and the logic 152 may comprise network analysis logic configured to infer the information by detecting a connection of personal portable devices 20 associated with the one or more participants 11-1 or 11-2 to the communications network 4.

It is appreciated that the communications network 4 may comprise a wired network and/or a wireless network. For example, the wireless network may comprise a Wireless Local Area Network (WLAN), such as a WLAN using technology known as Wi-Fi, a Personal Area Network (PAN), such as a PAN using technology known as Bluetooth, a Cellular Telephony Network, and/or a Satellite Communications Network.

As explained below, in some examples, the arrangement may be configured to detect the presence of a personal portable device 20. In some examples, the equipment 15 and/or the endpoint 11-1 may be configured to poll a Wi-Fi surveillance system to find out which personal portable devices 20 are in the vicinity of the endpoint 11-1 and who the personal portable devices 20 belong to. In some examples, the personal portable device 20 may exchange signals with the access point 114, e.g., via a wired connection and/or exchange of Wi-Fi and/or Bluetooth signals. The exchanged signals between the personal portable device 20 and the access point 114 may be used to determine actual distance of the personal portable device 20 to the transceiver access point 114. In some examples, the logic 152 may use ID of the access point 114 to determine the location of the connected personal portable device 20. Alternatively or additionally, the logic 152 may use Wi-Fi triangulation when the personal portable device 20 may connect to several access points 114. In some examples, if the logic 152 determines that the personal portable device 20 is located at an actual distance below a predetermined threshold, presence information may be inferred about the presence of the corresponding personal portable device 20, and thus information about the presence of the corresponding participant may be inferred. For example, the participant may be counted and/or identified, for example based on a count and/or ID of the corresponding personal portable device 20. The Wi-Fi signals and/or the Bluetooth signals may have a short range and may be blocked by walls of a room where the conferencing endpoint is located, and the personal portable devices 20 detected may correspond to participants in the room where the conferencing endpoint is located. Additionally or alternatively, the threshold may correspond to a size of a room where the conferencing endpoint is located.

Additionally or alternatively, in some examples, the element 151 of the arrangement may comprise a location system 115, and the logic 152 may comprise location analysis logic configured to infer the information using positioning of personal portable devices associated with the one or more participants.

In some examples, the location system 115 may comprise a positioning receiver 115-1 located in the device 20 and a positioning transceiver 115-2 located in the endpoint 11-1. The positioning receiver 115-1 may comprise a Global Positioning System (GPS), GLONASS, Galileo and/or Compass receiver. As explained below, in some examples, the arrangement may be configured to detect the presence of a personal portable device 20. For example, the personal portable device 20 may use the receiver 115-1 and the transceiver 115-2 to transmit signals, such as the location of the device 20 determined by the system 115, to the logic 152, e.g., via a wired connection and/or exchange of Wi-Fi and/or Bluetooth signals. The transmitted signals may be used to determine the location of the personal portable device 20, for example with respect to the location of the endpoint 11-1. In some examples, if the logic 152 determines that the personal portable device 20 is located at an actual distance below a predetermined threshold, presence information may be inferred about the presence of the corresponding personal portable device 20, and thus information about the presence of the corresponding participant may be inferred. For example, the participant may be counted and/or identified, for example based on a count and/or ID of the corresponding personal portable device 20. In some examples, the threshold may correspond to a size of a room where the conferencing endpoint is located.

Additionally or alternatively, in some examples, the element 151 of the arrangement may comprise an identification system 117, and the logic 152 may comprise identification analysis logic configured to infer the information using identification of personal identification devices associated with the one or more participants.

In some examples, the identification system 117 may comprise a personal identification device 117-1, located in the device 20 and/or carried by the participant 1-1, and a reader 117-2 located in the endpoint 11-1 or near the endpoint 11-1 (such as in a room where the endpoint 11-1 is located). The personal identification device 117-1 may comprise an Radio-Frequency Identification (RFID) tag and/or a Near Field Communication (NFC) tag. In some examples the device 117-1 may be incorporated in an ID tag (such as company ID card) and/or the device 20. In some examples the device 117-1 may incorporate identification information about the device 20 and/or the participant 1-1. As explained below, in some examples, the arrangement may be configured to detect the presence of a personal portable device 20 and/or a participant 1-1 using the personal identification device 117-1. For example, the personal identification device 117-1 may transmit to the reader 117-2 (e.g., using RFID and/or NFC technology) radio signals, such as the identification of the device 20 and/or the participant 1-1, which may be provided to the logic 152. The transmitted signals may be used to determine the identification of the personal portable device 20 and/or the participant 1-1. Presence information may be inferred about the presence of the corresponding personal portable device 20 and/or participant 1-1. For example, the participant may be counted and/or identified, for example based on a count and/or ID of the corresponding personal portable device 20.

Additionally or alternatively, in some examples, the arrangement may comprise logic or software running on a processor remote from the conferencing endpoint and arranged to infer presence based on network traffic and/or communication with equipment in a room where the conferencing endpoint is located.

In some examples, the inferring of the presence information may use a plurality of the methods described above in order to achieve cross-correlation.

In some examples, the threshold may correspond to a distance from the endpoint 11-1 which is considered as normal for participation in the call, such as for example a few meters.

In some examples, the determiner 102 may be configured to determine the additional call context information based on the inferred information. In some examples, the determiner 102 may be configured to filter the inferred information and/or the CNP, e.g., to render only a part of the inferred information, for example based on preferences set by an administrator and/or the calling participant and/or the called participant. In examples the format of the display of the additional call context information may be set in preferences set by the administrator and/or the calling participant and/or the called participant. For example, the determiner 102 may be configured to determine only the number of participants on the call, even if the participants were identified by the logic 152.

In some examples, the determiner 102 may be configured to enrich the inferred information, for example based on the CNP and/or the inferred information.

As already mentioned, alternatively or additionally, the endpoint 12-1 may be configured to comprise at least some of the functionalities or elements of the determiner 102. Alternatively or additionally, the presence detection equipment 15 may be configured to comprise at least some of the functionalities or elements of the determiner 102.

For example the endpoint 12-1 and/or logic 152 and/or the determiner 102 may implement a directory function required to resolve a participant's ID to count and/or identify based on the CNP and/or the inferred information. Additionally or alternatively, the endpoint 12-1 and/or the element 151 and/or the determiner 102 may store images and/or audio files and/or participants' locations as a source for face and/or voice and/or location recognition.

In some examples, the endpoint 12-1 and/or logic 152 and/or the determiner 102 may be configured to determine if all of the participants are recognized. Then the endpoint 12-1 and/or logic 152 and/or the determiner 102 may be configured to determine if a filter (for example just giving head count even if all of the participants are identified) and/or enrichment (for examples by retrieving more details about the identified participants, for example from storage) should apply, and the resulting additional call context information, for example the identification and/or details and/or head count, is provided to the endpoint 12-1 as appropriate. In some examples, if it is determined that not all of the participants are identified (for examples in cases where the faces of the detected participants are not recognized or are not in the database or directory), the endpoint 12-1 and/or logic 152 and/or the determiner 102 may be configured to provide valuable and useful additional call context information, by providing for example at least a head count of the not identified participants, for example along with identification and/or details and/or head count of the identified participants.

In some examples, the endpoint 11-1 may be configured to continuously gather information about its surroundings. In an example, the presence information may be inferred at a startup of the call or video conference. In an example where the presence information is inferred at the startup of the call or video conference, the results may be cached locally in the memory 105 in order to reduce the time for providing the inferred information to the determiner 102 and/or the communicator 103. In an example the presence information may be inferred during the call or video conference, for example when ad-hoc participants join an ongoing (i.e. in-progress) call or video conference. In an example, the presence information may be inferred on a request by a participant 1-1 or 1-2 during the call or video conference. In some examples, when the conference is pre-registered, the apparatus 10 (for example the endpoint 11-1 and/or the call manager 100) may be configured to include further information about the pre-registered conference, for example the title of the conference and/or the invited participants and/or the accepted participants and/or other available information about the conference (for example available using software known as Exchange or other) in the additional call context information (for example as a topic of the conference and/or title of the call notification), thus providing valuable and useful additional call context information to the called participant.

In some examples, the apparatus 10 (for example the endpoint 11-1 and/or the call manager 100) may be configured to determine if a file, such as a using software known as Powerpoint or Word, is being presented when the call is initiated. In some examples, the apparatus 10 (for example the endpoint 11-1 and/or the call manager 100) may be configured to include the name of the file in the additional call context information (for example as a topic of the conference and/or title of the call notification). It is appreciated that this additional call context information may provide valuable and useful additional call context information to the called participant.

In some examples, the additional call context information may comprise information indicating that more than one participant is present; a number of participants present, a list of participants present, and/or contact details of participants present.

The additional call context information may be rendered in any form. For example the additional call context information may be configured to be rendered in a video clip, an audio clip, a text, and/or a picture. For example, the additional call context information may be text-based and include a list of participant names. Also, a video clip or snapshot may be included in the message. For example, if a video-conference is being provided, a snapshot and/or a video clip from the video-conference with the participants in it (for example taken by the camera 111 of the endpoint 11-1 when the call is initiated) may be included in the message as the list of participants. In some examples, the snapshot may be sent using Real-time Transport Protocol, for example in parallel with the call request or using another server-based method, such as a cloud service.

As already explained, the apparatus 10 (for example the endpoint 12-1 and/or the call manager 100 (for example the determiner 102) and/or the presence detection equipment 15) may be configured to retrieve the additional call context information based on the inferred information from storage, such as the memory 16. In some examples, the apparatus 10 may be configured to determine the additional call context information based on the CNP. In an example, the memory 16 may comprises a database 160. The database 160 may include additional information about the participants 1 and/or 2, such as locations of corresponding endpoints 11 and/or 12, profiles of the participants 1 and/or 2, policies to be applied for particular video conferencing arrangements, user preferences, references associated with a particular host, administrator or of the participants 1 and/or 2, and any other information that may be used by an administrator and/or the apparatus 10 to perform the intended functionality as described herein.

In an example, the apparatus 10 may be further configured to retrieve additional information from storage, for example from the database 160, once the participants 1-1 and 1-2 are identified.

In an example, the additional information may comprise at least any one of the following: a forename; a family name; a company name; a department name; a job title; an organizational role; a skill; an expertise; a location; a contact detail; a telephone number; a mail address; an email address; a calendar availability status; an instant messaging availability status; a community membership; a social network membership; an identification of a social network connection; an interest; a recent work; and/or a recent publication, etc.

The database 160 may be comprised at least partly in a collaboration system, an identity platform, and/or a corporate directory. In the example of FIG. 1, the database 160 may be positioned outside the call manager 100 (e.g., in a network device coupled to the call manager). In some examples, the database 160 may be provisioned internally within the call manager 100, or locally at a particular network location which could foster communications with the call manager 100 and/or the endpoint 12-1 and/or the presence detection equipment 15 and/or the determiner 102 or any combination thereof. Certain participant information may be populated in the call manager 100 and/or the endpoint 12-1, the presence detection equipment 15 and/or the determiner 102.

In some examples, the communicator 103 may be configured to receive the call request from call request receiver 101. In some examples, the communicator 103 may further be configured to receive the additional call context information determined by the determiner 102. In some examples, the communicator 103 may be configured to send the additional call context information to the called participant in addition to the call, via the endpoint 12-1. When the call or invite message is received, the endpoint 12-1 can access the additional call context information.

As already mentioned, alternatively or additionally, the endpoint 12-1 may be configured to comprise at least some of the functionalities or elements of the communicator 103.

The communicator 103 may be configured to provide the additional call context information in different ways.

In some examples, the additional call context information may be included as caller ID information. For example the additional call context information may be configured to be rendered as caller ID information when an incoming call message is received at the called conferencing endpoint 12-1 associated with the called participant 2-1. For example, the additional call context information may be provided in the caller ID field of the call, and the additional call context information may be accessible to the participant 2-1 when the call is received. For example, if the additional call context information is included in the caller ID field, the additional call context information may be automatically rendered as caller ID information when the call is received.

As already explained, in some examples the call is a video conference call may be implemented in a Session Initiation Protocol (SIP) environment. In some examples the apparatus 10 may be configured to handle the SIP session from the conferencing endpoint 11-1 over the Internet Protocol network used in the SIP session. For example the apparatus 10 may be configured to generate a SIP invite request for the invited participant. In some examples, the request may comprise a Call-Info header field, and the inferred information may be provided in the Call-Info header field. In some examples, the Call-Info field may provide additional information about the inviting participant. In some examples, the Call-Info field may comprise a “purpose” parameter describing the purpose of a Uniform Resource Identifier (URI). In some examples an “icon” parameter may designate an image suitable as an iconic representation of the inviting participant. In some examples an “info” parameter may describe the inviting participant in general, for example, through a web page. In some examples, a “card” parameter may provide a business card, for example, in vCard or LDAP (Lightweight Directory Access Protocol) Data Interchange Format (LDIF) formats. In some examples, a SIP call request may comprise a parameter for a count for the participants, a parameter for the ID of the participants (which may be retrieved by the endpoint 12-1 by polling storage such as a directory such as the database 160 already described), and/or a parameter for the full name of the participants.

As already explained, in some examples the call may be implemented at least partly in a mobile and/or cellular and/or satellite telephony environment. In some examples, an application may run on the endpoint 12-1 forming a portable personal device which may comprise at least one of a telephone, such as a mobile and/or cell and/or satellite phone and/or a smart phone, or object capable of connection to the communications network 14. In some examples the application on the endpoint 12-1 may then be configured to receive the additional call context information from a platform 17 comprising a server included in the apparatus 10, for example connected to the call manager 100. For example the additional call context information may be pushed to the endpoint 12-1 via the network 14 in an appropriate format to be rendered by the application on endpoint 12-1. Alternatively or additionally in some examples the application on the endpoint 12-1 may then be configured to retrieve (or pull) the additional call context information from the platform 17 over the network 14. In both cases, the application may then allow render of the additional call context information.

The endpoint 12-1 or any other device may render the additional call context information in a display, such as the screen 123. In one embodiment, the caller ID field of the endpoint 12-1 may display the list of participants. An example of the information displayed may be “participant 1-1 with one other participant” or “participant 1-1 with participant 1-2”. Other methods of rendering the list of participants may include playing a video clip, audio clip, etc. For example, the video clip of the participants 1-1 and 1-2 may be played.

In some embodiments, the communicator 103 may be configured to set information in the call such that the call receives a certain priority. For example, if a called participant has rules that filter calls from a certain calling participant, communicator 103 may be configured to set information that overrides the rules. Thus, the call may be approved and forwarded to the endpoint 12-1 even if the calling participant 1-1 is not on an approved list of participants who are permitted to contact the called participant 2-1.

In some examples, a portable personal device 20 may be associated with, or allocated to, a particular participant, e.g., participants 1-1 and 1-2. A portable personal device 20 may belong to a participant, such as the participant 1-1. In some embodiments, in operation the call and/or the video conference session may be in a “bring your own device” scenario.

In examples, the portable personal devices 20 may comprise at least one of a telephone, such as a mobile and/or cell and/or satellite phone, a computer, a personal digital assistant (PDA), a laptop or electronic notebook, a smart phone, a tablet, any other type of smart device, component, element, or object capable of connection to the communications network 4. For example the portable personal devices 20 may include a suitable interface to the participant, e.g., 1-1, such any one of the following as appropriate for the call, such as a microphone, a camera, a screen as a display device and/or a touch screen, and/or a keyboard, or any other terminal equipment, such as a mouse or a touch pad.

In some embodiments, the portable personal devices 20 may be configured to initiate at least one of video, voice, audio, or data exchanges within the apparatus 10. In embodiments, the portable personal devices 20 may be configured to receive at least one of a video stream and/or an audio stream and/or an information stream of a call or a video conference session.

In some examples, the call, e.g. to participant 2-2, may be provided during an ongoing conference between at least a calling participant, e.g. participants 1-1 and 1-2, associated with the conferencing endpoint 11-1, and one or more remote participants 2-1 and 2-3 associated with the conferencing endpoint 12-1. In some examples, the apparatus 10 may be configured to provide additional call context information to the called participant 2-2 in addition to an invite to the ongoing conference. In some examples, the additional call context information may be determined based on presence information inferred based on a detection of the one or more participants 1-1, 1-2, 2-1, 2-3 in the ongoing conference by the presence detection equipment 15 respectively associated with the conferencing endpoint 11-1 associated with the calling participants 1-1 and 1-2, and with conferencing endpoint 12-1 associated with the one or more remote participants 2-1 and 2-3. In one example, the participants 1-1, 1-2, 2-1 and 2-3 are in a conference call. One of the participants, such as the participant 1-1 may use the endpoint 11-1 to place an ad hoc conference call. In this case, the participant 1-1 may place the conference call on hold and out-dial the endpoint 12-2 in an ad hoc manner.

In some examples, the message builder 104 may be configured to determine which participants, for example participants 1-1 and 1-3, are participating in the ongoing conference. For example, information may be included in the invite message identifying a conference. The message builder 104 may determine which participants, for example participants 1-1 and 1-3, are participating in the conference from the memory 105. For example, a conference ID or session ID may be used to retrieve a roster of the participants 1-1 and 1-3 in the conference. In other embodiments, the message builder 104 may communicate with other systems, such as a conferencing system, to determine the list of the participants 1-1 and 1-3. As explained above, other methods for determining the list of participants may also be appreciated. For example, the list of participants 1-1 and 1-3 may be sent with an initial invite message from endpoint 11-1. Additionally or alternatively, a list of participant IDs may be sent, and the message builder 104 may be configured to determine usernames for the IDs. Additionally or alternatively, the message builder 104 may look up the usernames and add them as the list of participants 1-1 and 1-3.

In some examples, the endpoint 12-1 may be configured to automatically render the additional call context information in caller ID information. In this case, a number and/or a list of participants may be included in the caller ID information and displayed for the participant 2-2. For example, the caller ID information may state “participant 1-1 calling with three other participants” or “participant 1-1 calling on behalf of a conference with participants 1-2, 2-1, and 2-3” in the caller ID information field.

In some embodiments, the conference may be pre-planned and context information about the conference may be stored in a database, such as database 160 of memory 16. In some examples, the context information may comprise information such as:
a title of the conference,
a topic of the conference,
an agenda of the conference,
a planned duration of the conference,
a lapsed duration since a starting time of the conference,
a remaining duration to a planned end time of the conference.

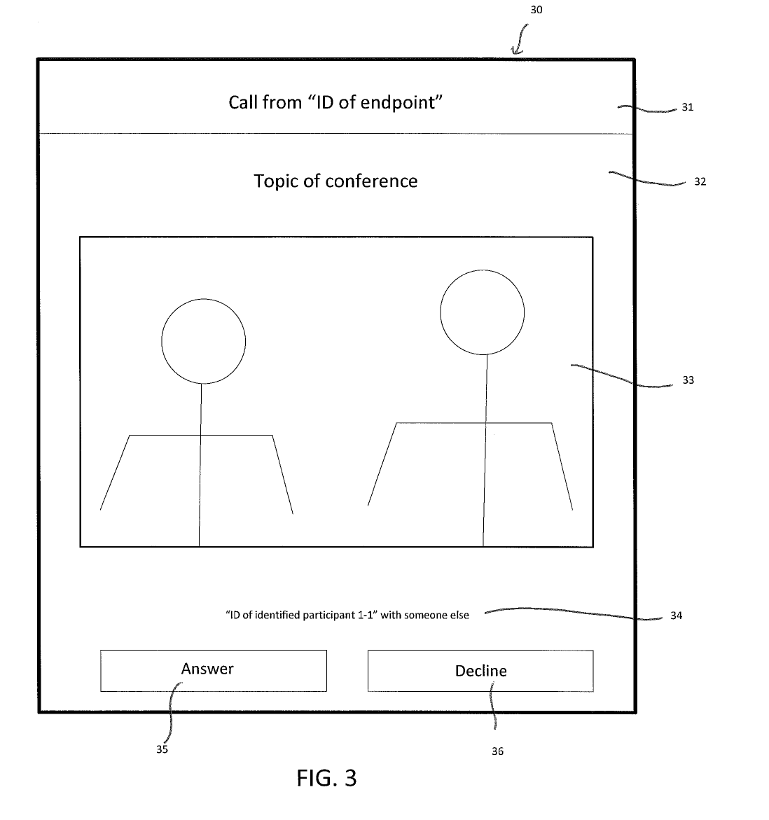

In the example of FIG. 3, an example interface rendering the call context information comprises a field 31 rendering the ID of the endpoint 11-1, a field 32 rendering the topic of the conference, a field 33 showing a picture of the participants 1-1 and 1-2 (such as a snapshot taken by the camera 111 or pre-stored pictures of the participants), a field 34 rendering the ID of an identified participant 1-1 and a message (such as “with someone else”) showing that participant 1-2 was counted but not identified. The interface 30 may also comprise buttons 35 and 36 (which can be software buttons) to respectively answer or decline the call.

In some embodiments, the additional call context information may comprise a subset of participants actually participating in the call or conference, based on preferences of the one or more participants. In some examples some counted and/or identified participants do not wish their ID and/or some of their details to be rendered in the additional call context information.

In some embodiments, the apparatus 10 may be configured to prompt the calling participants 1-1, 1-2, 1-3 and/or 1-4, e.g., using a preview (for example on the endpoint 11-1) of the information which is intended to be sent to the called participant. In some embodiments, the apparatus 10 may be configured to enable the calling participants 1-1, 1-2, 1-3 and/or 1-4 to edit the information and add and/or remove and/or amend the information, such as names and/or conference topic and/or title, before initiating the call. In some embodiments, the call manager 100 may prompt the participants 1-1, 1-2, 1-3 and/or 1-4 to determine if they desire e.g., their names to be released in the additional call context information. For example, the call request receiver 102 may message with each endpoint device 11-1 and 11-3 to determine if the participants 1-1, 1-2, 1-3 and/or 1-4 want their details (such as their name) to be included in the list additional call context. Accordingly, it may be possible that not all participants 1-1, 1-2, 1-3 and/or 1-4 participating in the call or the ongoing conference be included in the additional call context. This may also be true even if the participants 1-1, 1-2, 1-3 and/or 1-4 are not prompted. For example, preferences may be set such that certain participants are not included in an additional call context automatically.

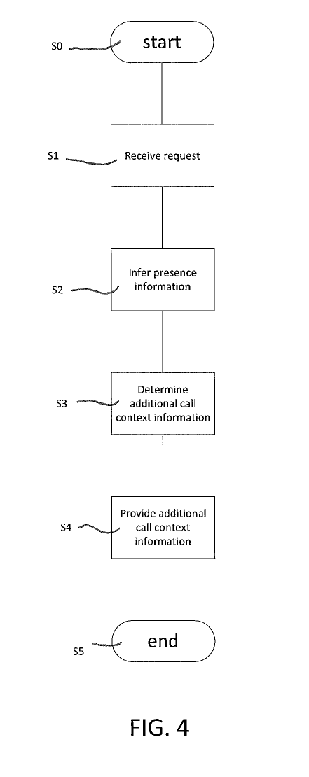

FIG. 4 depicts a simplified flow chart of a method for handling a call according to one embodiment of the present disclosure.

The method starts at S0. At S1 the call manager 100 and/or the endpoint 11-1 receives the request to call the called participant from the conferencing endpoint 11-1. At S2, the presence detection equipment 15 and/or the endpoint 11-1 infers information about the presence of the one or more participants in the call. At S3, the call manager 100 and/or the endpoint 12-1 determines additional call context information based on the inferred information. At S4 the call manager 100 and/or the endpoint 12-1 provides the additional call context information to the called participant in addition to the call.

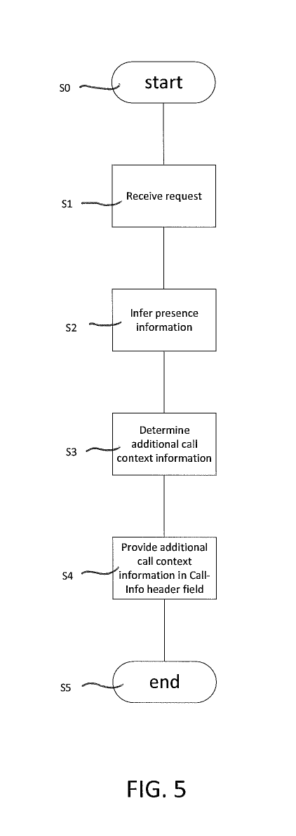

FIG. 5 depicts a simplified flow chart of a method for handling a SIP session according to one embodiment of the present disclosure where in S4 the inferred information is provided in the Call-Info header field.

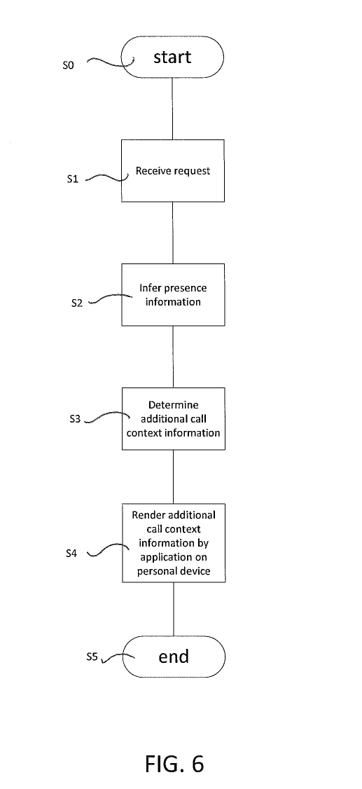

FIG. 6 depicts a simplified flow chart of a method for handling a call to an endpoint comprising a mobile phone according to one embodiment of the present disclosure where in S4 the inferred information is configured to be rendered by an application running on the endpoint associated with the invited participant.

It has been explained that the additional call context information may be included in a caller ID. Alternatively or additionally, the additional call context information may be included in envelope information. If the information is included in the envelope information, the called participant may choose to retrieve the list of participants from the envelope information.

In some embodiments, the communicator 103 may be configured to send a call and/or a invite and/or the additional call context information through a plurality of modalities. A modality may refer to a mode of communication. A voice modality may refer to any mechanism for transferring voice information and may include systems such as a plain old telephone service network (POTS), a cellular network, a voice-over IP network, etc. Other modalities may also be appreciated, such as an instant message modality, video modality, e-mail modality, etc. It will be understood that embodiments of the present disclosure may be used with any modality. Thus, for example, the conference may be an instant messaging conference, video conference, etc. Also, multiple modalities may be used in a conference, such as phone and video modalities may be used in a conference.

The communicator 103 may determine which modality may be the best modality to send the additional call context information to the invited participant. For example, if the inferred information indicates the invited participant is active on an instant messaging modality, the communicator 103 may decide to send the additional call context information through the instant message modality. Presence may be stored in the memory 16 for the invited participant. The communicator 103 may determine which modality the invited participant is active based on information in the memory 16. Then the additional call context information may be sent to the invited participant through one or more of the modalities on which they are active. For example, an instant message and a phone call may be sent inviting the invited participant into the conference. Both messages may include the list of participants. In another example, instant message modality may be used.

Some or all of the functionalities of the call manager 100 may be included in one or more of the endpoints 11 and/or 12.

Although the disclosure describes specific embodiments, these embodiments are merely illustrative, and not restrictive of the invention. It will be recognized that embodiments of the present disclosure may be used in any modality. Although voice may be discussed, other modalities may be appreciated. Also, a PBX system may include any telecommunications system, such as a TDM voice switch, VoIP multimedia system, etc.

As used herein in this specification, the term ‘screen’ is meant to designate any element that is capable of displaying an image during a video conference session. This would be inclusive of any panel, display device, telepresence display or wall, computer display, plasma element, television, monitor, at least one window or any other suitable surface or element that is capable of such displaying. Moreover, the screen can encompass each window in a “picture in picture” display on a single display device, where multiple videos or images may be displayed simultaneously, for example, in separate adjacent windows, or in one or more inset windows inside a larger window.

In embodiments, the apparatus 10 may comprise a multipoint control unit (MCU), for example comprised in the call manager 100, which can be coupled to endpoint 11 and 12 and which may comprise, in embodiments, a multipoint manager element. The multipoint manager element may help to coordinate and to process information being transmitted by the participants 1 and 2. The MCU can be configured to establish, or to foster, the video conference session between the participants 1 and 2.

In some examples, the apparatus 10 may be configured such that the apparatus MCU may perform all the calls out to the endpoints 11 and 12. In some examples, the call manager 100 and/or the MCU may perform all the calls out to the endpoints 11 and 12, for examples for scheduled conferences, such that all the participants 1 and 2 are invited into a conference.

In some examples, all the endpoints 11 and 12 may call the apparatus 10. In some examples, all the endpoints 11 and 12 may call into a central server, such as the call manager 100 and/or the MCU, as non-limiting examples.

The MCU and the multipoint manager element can coordinate and process various policies involving the endpoints 11 and 12. In general, the MCU and the multipoint manager element may communicate with the endpoints 11 and 12 through any standard or proprietary conference control protocol. The multipoint manager element may include a switching component that determines which signals are to be routed to the individual endpoints 11 and 12 for displaying on the screens. The multipoint manager element can also determine how individual participants 1 and 2 are seen by other participants in the video conference session. The multipoint manager element can add visual information to video signals sent to endpoints. For example, the multipoint manager element can generate notifications and send the notifications to participants (e.g., after mixing and overlaying text messages, audio cues, graphics, etc. on outgoing video signals to the endpoints). Furthermore, the multipoint manager element can control the timing and coordination of these activities. The multipoint manager element can also include a media layer that can copy information or data, which can be subsequently retransmitted or simply forwarded along to one or more of the endpoints 11 and 12.

The call manager 100 and/or the endpoints 11 or 12 and/or the multipoint manager element may include a processor and a memory.

As will be apparent to the skilled in the art, in the following specification the servers (for example the server of the platform 17) should not be understood as a single entity, but rather refers to a physical device comprising at least a processor and a memory, the memory being comprised in one or more servers which can be located in a single location or can be remote from each other to form a distributed network (such as “server farms”, e.g., using wired or wireless technology).

Any suitable programming language can be used to implement the routines of embodiments of the present disclosure including C, C++, Java, assembly language, etc. Different programming techniques can be employed such as procedural or object oriented. The routines can execute on a single processing device or multiple processors. Although the steps, operations, or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

Functions can be performed in hardware, software, or a combination of both. Unless otherwise stated, functions may also be performed manually, in whole or in part.

In the description herein, numerous specific details are provided, such as examples of components and/or methods, to provide a thorough understanding of embodiments of the present disclosure. One skilled in the relevant art will recognize, however, that an embodiment of the disclosure can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present disclosure.

A “computer-readable medium” for purposes of embodiments of the present disclosure may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

Embodiments of the present disclosure can be implemented in the form of control logic in software or hardware or a combination of both. The control logic may be stored in an information storage medium, such as a computer-readable medium, as a plurality of instructions adapted to direct an information processing device to perform a set of steps disclosed in embodiments of the present disclosure. Based on the disclosure and teachings provided herein, a person of ordinary skill in the art will appreciate other ways and/or methods to implement the present disclosure.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present disclosure and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present disclosure may be combined in any suitable manner with one or more other embodiments. It is to be understood that other variations and modifications of the embodiments of the present disclosure described and illustrated herein are possible in light of the teachings herein and are to be considered as part of the spirit and scope of the present invention.

Embodiments of the disclosure may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of embodiments of the present disclosure can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present disclosure, including what is described in the Abstract, is not intended to be exhaustive or to limit the invention to the precise forms disclosed herein. While specific embodiments of, and examples for, the disclosure are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present disclosure has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for handling a call from a conferencing endpoint configured to handle a conference between multiple participants, the method comprising:
receiving a request to call a participant from the conferencing endpoint;
inferring information about a presence of one or more participants in the call, based on a detection of the one or more participants by presence detection equipment associated with the conferencing endpoint;
determining additional call context information based on the inferred information; and
providing the additional call context information to the participant in addition to the call, wherein the additional call context information is accessible to the participant.

2. The method of claim 1, wherein the inferring comprises detecting the presence of one or more participants in a room where the conferencing endpoint is located.

3. The method of claim 1, wherein the presence detection equipment comprises at least one arrangement chosen from the group consisting of:
a camera and image analysis logic configured to infer the information using a method chosen from the group consisting of: face detection, face recognition, head count, any of the foregoing;
a microphone and audio analysis logic configured to infer the information using a method chosen from the group consisting of: voice detection, voice recognition, any of the foregoing;
an ultrasound transceiver and device detection logic configured to infer the information by detecting ultrasound emitted or received by personal portable devices associated with the one or more participants;
an access point of a communications network and network analysis logic configured to infer the information by detecting a connection of personal portable devices associated with the one or more participants to the communications network;
a location system and location analysis logic configured to infer the information using positioning of personal portable devices associated with the one or more participants;
an identification system and identification analysis logic configured to infer the information using identification of personal identification devices associated with the one or more participants;
logic or software running on a processor remote from the conferencing endpoint and arranged to infer presence based on network traffic and/or communication with equipment in a room where the conferencing endpoint is located;
any of the foregoing.

4. The method of claim 3, wherein the communications network is chosen from the group consisting of: a wired network, a wireless network, any of the foregoing.

5. The method of claim 4, wherein the wireless network is chosen from the group consisting of: a Wireless Local Area Network (WLAN), a Personal Area Network (PAN), a Cellular Telephony Network, a Satellite Communications Network, any of the foregoing.

6. The method of claim 1, wherein the additional call context information is included as caller ID information.

7. The method of claim 6, wherein the additional call context information is configured to be rendered as caller ID information when an incoming call message is received at a conferencing endpoint associated with the participant.

8. The method of claim 1, wherein the additional call context information comprises information chosen from the group consisting of:
information indicating that more than one participant is present;
a number of participants present,
a list of participants present,
contact details of participants present,
a name of a file being used during the call,
any combination of the foregoing.

9. The method of claim 1,
wherein the call is provided during an ongoing conference between at least a first participant, associated with the conferencing endpoint, and one or more remote second participants associated with conferencing endpoints,
the method further comprising providing additional call context information to the participant in addition to an invite to the ongoing conference,
wherein the additional call context information is determined based on presence information inferred based on a detection of one or more participants in the ongoing conference by presence detection equipment associated with the conferencing endpoint associated with the first participant and with the conferencing endpoints associated with the one or more remote second participants.

10. The method of claim 9, wherein the conference is preplanned and context information about the conference is stored in a database.

11. The method of claim 10, wherein the context information comprises information chosen from the group consisting of:
a title of the conference,
a topic of the conference,
an agenda of the conference,
a planned duration of the conference,
a lapsed duration since a starting time of the conference,
a remaining duration to a planned end time of the conference,
any combination of the foregoing.

12. The method of claim 1, wherein the additional call context information is configured to be rendered in a format chosen from the group consisting of a video clip, an audio clip, a text, a picture, any combination of the foregoing.

13. The method of claim 1, wherein the additional call context information comprises a subset of participants actually participating in the call, based on preferences of the multiple participants.

14. The method of claim 1, wherein the call is chosen from the group consisting of audio call, video call, any combination of the foregoing.

15. An apparatus configured to handle a call from a conferencing endpoint configured to handle a conference between multiple participants, the apparatus comprising:
a call request receiver configured to receive a request to call a participant from the conferencing endpoint;
a presence detector associated with the conferencing endpoint and configured to infer information about a presence of one or more participants in the call;
a determiner configured to determine additional call context information based on the inferred information; and
a communicator configured to provide the additional call context information to the participant in addition to the call, wherein the additional call context information is accessible to the participant.

16. The apparatus of claim 15, wherein the presence detector is configured to detect the presence of one or more participants in a room where the conferencing endpoint is located.

17. The apparatus of claim 15, wherein the presence detector comprises at least one arrangement chosen from the group consisting of:
a camera and image analysis logic configured to infer the information using a method chosen from the group consisting of: face detection, face recognition, head count, any of the foregoing;
a microphone and audio analysis logic configured to infer the information using a method chosen from the group consisting of: voice detection, voice recognition, any of the foregoing;
an ultrasound transceiver and device detection logic configured to infer the information by detecting ultrasound emitted or received by personal portable devices associated with the one or more participants;
an access point of a communications network and network analysis logic configured to infer the information by detecting a connection of personal portable devices associated with the one or more participants to the communications network;
a location system and location analysis logic configured to infer the information using positioning of personal portable devices associated with the one or more participants;
an identification system and identification analysis logic configured to infer the information using identification of personal identification devices associated with the one or more participants;
logic or software running on a processor remote from the conferencing endpoint and arranged to infer presence based on network traffic and/or communication with equipment in a room where the conferencing endpoint is located;
any of the foregoing.

18. The apparatus of claim 15, wherein the communicator is configured to provide the additional call context information as caller ID information.

19. The apparatus of claim 15,
configured to provide the call during an ongoing conference between at least a first participant, associated with the conferencing endpoint, and one or more remote second participants associated with conferencing endpoints,
the communicator being further configured to provide additional call context information to the participant in addition to an invite to the ongoing conference,
wherein the additional call context information is determined based on presence information inferred based on a detection of one or more participants in the ongoing conference by presence detector associated with the conferencing endpoint associated with the first participant and with the conferencing endpoints associated with the one or more remote second participants.

20. Logic encoded in a non-transitory medium which includes code for execution of a method and when executed by a processor operable to perform operations, comprises:
receiving a request to call a participant from a conferencing endpoint configured to handle a conference between multiple participants;
inferring information about a presence of one or more participants in the call, based on a detection of the one or more participants by presence detection equipment associated with the conferencing endpoint;
determining additional call context information based on the inferred information; and
providing the additional call context information to the participant in addition to the call, wherein the additional call context information is accessible to the participant.
